(19) United States
(12) Patent Application Publication
(10) Pub. No.: US 2002/0150823 A1
(43) Pub. Date: Oct. 17, 2002

(54) Atmospheric pressure CVD grown lithium ion-conducting electrolyte

(76) Inventors: Richard C. Breitkopf, Atlanta, GA (US); Ahmet Erbil, Atlanta, GA (US)

Correspondence Address: Edwina Thomas Washington, EXCELLATRON SOLID STATE, LLC, 1640 Roswell Street, Suite J, Smyrna, GA, 30080, US

(21) Appl. No.: 09/832,386

(22) Filed: Apr. 11, 2001

(51) Int. Cl. H01M 4/66; H01M 6/18

(52) U.S. Cl. 429/245; 29/623.5; 429/319; 429/322

(57) ABSTRACT

Systems and methods for providing an atmospheric pressure chemical vapor deposition grown lithium ion conducting electrolyte component of a thin film battery. The thin film battery generally includes a substrate, a sequentially deposited ensemble of thin film layers including at least one current collector, and an electrolyte sandwiched between a cathode and an anode. The current collecting layer may be positioned on a portion of the substrate to allow good electrical contact with the anode or cathode and an external charging device. A protective coating may be placed over the thin film battery to protect the battery from deterioration when exposed to atmospheric conditions, elevated temperatures and certain manufacturing processes. A process involving preparation of a solution including volatile lithium, aluminum and phosphorus compounds that is sprayed onto a heated substrate containing a thin film layer current collector makes the electrolyte thin film layer. The result forms a mixed oxide material for instance, Li₂O-xAl₂O₃-yP₂O₅. The mixed oxide material is post-treated in ammonia at atmospheric pressure and at selected elevated temperatures, for instance 500° C. The result is an ion-conducting electrolyte.

### FIELD OF THE INVENTION

This invention relates generally to deposition processes used to prepare thin film batteries, and more particularly, to systems and methods for an atmospheric pressure chemical vapor deposition (CVD) grown lithium ion-conducting electrolyte.

### BACKGROUND OF THE INVENTION

Thin film lithium batteries have existed for many years. These batteries have high energy and power densities as well as the capability of being cycled thousands of times making these batteries ideal for a number of applications having limited space for energy storage devices. Current methods and systems for manufacturing thin film batteries generally utilize slow deposition processes to produce each thin film layer.

Typically, thin film batteries include thin film layers of at least a cathode, anode and electrolyte. A key component of the thin film battery is the electrolyte that serves as an ionically conducting medium in which ions can move freely but electrons are blocked.

Currently, one method for depositing the thin film layers onto a surface such as a substrate is by sputtering. Sputtering involves ion bombardment of a target material such as lithium orthophosphate and subsequent release of atoms from the target that in turn deposit on a substrate. This process is effectuated by action of a high voltage on an ionizable gas such as argon under reduced pressure conditions. Momentum is transferred from accelerated ions to target atoms that coat the substrate when released. Reactive sputtering occurs when gaseous ions are sputtered in a reactive atmosphere such as nitrogen, oxygen, methane or any other gas that contains an element to be incorporated in the thin films that is not already present in the target material. One material produced by the reactive sputtering process is lithium phosphorus oxynitride (LiₓP_{y}ON_{z}) that can be used as an electrolyte. While sputtering produces good adhesion and composition control, this process has a low deposition rate.

All other methods including electron beam evaporation or other techniques have limitations such as low conductivity of the deposited electrolyte film and a slow deposition rate. In addition, most CVD processes require extremely low-pressure environments within a range of 0.1-100 Torr. This requirement greatly increases the cost of production and greatly reduces the feasibility of producing commercially viable products due to high costs of vacuum equipment. For example, metallo-organic CVD (MOCVD) involves the use of metallo-organic compounds as precursors. MOCVD reactions can occur at temperatures between 600-1000° C. and at pressures between 1 Torr and atmospheric pressure. In a typical semiconductor operation, the MOCVD process requires precise equipment, vacuum chambers, pumps and high purity gases. Thus the equipment and precursors costs make the existing MOCVD process cost prohibitive for thin film battery applications.

Accordingly, a need exists for deposition methods and systems that provide an electrolyte that is produced with a process having a higher deposition rate, inexpensive equipment and results in an increased throughput and conductivity.

### SUMMARY OF THE INVENTION

Systems and methods for providing an atmospheric pressure chemical vapor deposition grown lithium ion-conducting electrolyte component of a thin film battery. The thin film battery generally includes a substrate, a plurality of thin film layers including at least one current collector, and an electrolyte sandwiched between a cathode and an anode. A contact may be positioned on a portion of the substrate. A protective coating may be placed over the thin film battery to protect the battery from deterioration when exposed to atmospheric conditions, elevated temperatures and certain manufacturing processes.

The electrolyte thin film layer is made in accordance with the systems and methods of this invention. The inventive process involves preparing a solution including volatile lithium, aluminum and phosphorus compounds that is sprayed onto a heated substrate containing a thin film layer current collector. The result forms a mixed oxide material, for instance, Li₂O-xAl₂O₃-yP₂O₅. The mixed oxide material is annealed in ammonia at atmospheric pressure at a selected temperature, for instance 500° C. The result is an ion-conducting electrolyte.

In an alternative embodiment of this invention, the ion-conducting electrolyte is prepared by a plasma enhanced chemical vapor deposition process using volatile sources of lithium and phosphorus contained in separate vessels and transported to the deposition zone by vacuum sublimination. The entrained vapors react in the plasma and deposit onto a substrate maintained at temperature between room temperature and 250° C. Nitrogen plasma maintained at a reduced pressure reacts with precursors to allow for removal of carbon and formation of oxynitride phase at substrate temperatures below 300° C.

This invention accordingly aims to achieve at least one, more or combinations of the following objectives:

To provide for an atmospheric pressure CVD grown lithium ion-conducting electrolyte.

To provide a process for post-treating a mixed oxide material in ammonia and annealing the material to achieve good ionic conductivity.

To provide a lithium ion-conducting electrolyte using processes that provide better throughput using higher deposition rates.

To provide an ion-conducting electrolyte using a plasma enhanced chemical vapor deposition process.

To provide a lithium ion conducting electrolyte produced using an open-air deposition process.

To provide a lithium ion-conducting electrolyte that allows for flexibility in the configuration and arrangement of equipment used in the manufacturing process.

Other objects, advantages and features of the systems and methods of this invention will be set forth in part in the description which follows and in part will be obvious from the description or may be learned by practice of the invention. The objects, advantages and features of this invention will be realized and attained by means of the elements and combinations particularly pointed out in the claims.

### BRIEF DESCRIPTION OF THE DRAWINGS

FIG. 1 is a flow chart of a process for an atmospheric pressure chemical vapor deposition (CVD) grown lithium ion-conducting electrolyte in accordance with one aspect of this invention.

FIG. 2 is a flow chart of a process for making a thin film battery having the ion-conducting electrolyte as provided in FIG. 1.

FIG. 3 is a side view of a thin film battery having the ion-conducting electrolyte made from the process shown in FIG. 2.

FIG. 4 is a graph displaying impedance versus frequency performance results obtained prior to post-treating of the electrolyte.

FIG. 5 is a graph displaying the impedance versus frequency performance results of the ion-conducting electrolyte of FIGS. 2 and 3 after post-treating of the electrolyte.

### DETAILED DESCRIPTION

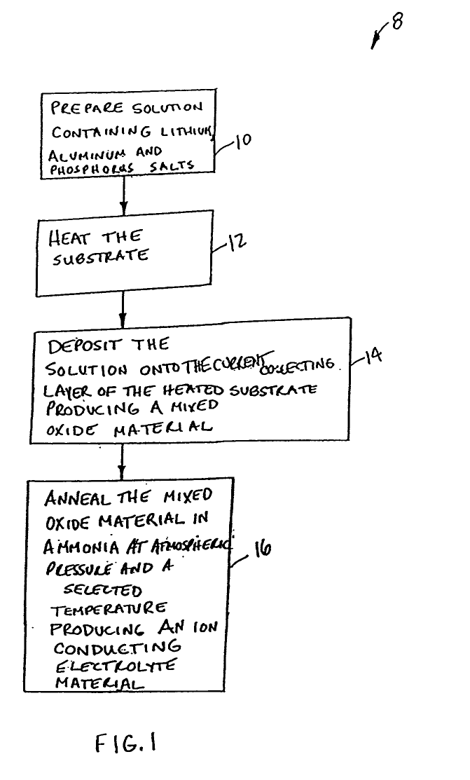

Reference will now be made in detail to preferred embodiments of the invention, examples of which are illustrated in the accompanying drawings. FIGS. 1-5 depict various aspects for systems and methods of providing for an atmospheric pressure chemical vapor deposition (CVD) grown lithium ion-conducting electrolyte in accordance with this invention.

FIG. 1 is a flow chart 8 of a process for an atmospheric pressure CVD grown lithium ion conducting electrolyte in accordance with one aspect of this invention. At 10, a solution including lithium, aluminum and phosphorus compounds is prepared. Typically, the solution will be sprayed onto a substrate prepared to receive the deposition. A suitable substrate includes a ceramic substrate available from Coors, Clear Creek Valley, 17750 W. 32^{nd} Avenue, P.O. Box 4011, Golden. Colo. 80401-001, and flexible substrates such as Kapton that are available from American Durafilm, 55-T Boynton Road, P.O. Box 6770, Holliston, Mass. 01746. When the electrolyte envisioned by this invention is used in a thin film battery application, either substrate can be used and the substrate has a current collector deposited thereon. A suitable current collector includes, for example, a multilayer deposition of gold on top of a cobalt or gold on top of titanium underlayer or on top of a thin film cathode material such as LiCoO₂, LiMn₂O₄ or V₂O₅.

At 12, the substrate having the current collector deposited thereon is heated. In a preferred embodiment, the substrate is heated to a temperature between 300 and 500° C. At 14, the solution containing lithium, aluminum and phosphorus compounds is deposited onto the heated substrate. The solution can be deposited by spraying the solution onto the heated substrate using for instance, a chemical vapor deposition process (CVD). The CVD process involves thermal decomposition of a solution containing compounds of the desired elements to be deposited. This invention uses for instance, volatile phosphorus, aluminum and lithium compounds that are delivered to a hot substrate by aerosol spray at which point they are flash vaporized and reacted to form the desired solid film. The chemical reaction results in a mixed oxide material of for instance, Li₂O-xAl₂O₃-yP₂O₅.

At 16, the mixed oxide material is post-annealed in ammonia at atmospheric pressure at a selected temperature for instance, 500° C. The result is a thin film material exhibiting ion-conducting behavior having a conductivity ca. about 2×10⁻⁷ S/cm. Annealing in ammonia is one important procedure for achieving high ionic conductivity in the thin films due to the nitrogen incorporation from this process. Nitrogen incorporation increases ionic conductivity because the nitride phase present provides weaker bonding to the lithium ions that in turn exhibit greater mobility.

In an alternative embodiment of this invention, the ion conducting electrolyte is prepared by a plasma enhanced chemical vapor deposition process using volatile sources of lithium and phosphorus contained in separate vessels and transported to the deposition zone by vacuum sublimination onto a substrate maintained at temperature between room temperature and 250° C. Nitrogen plasma at a reduced pressure reacts with the precursors to allow for removal of carbon and formation of oxynitride phase at substrate temperatures below 300° C.

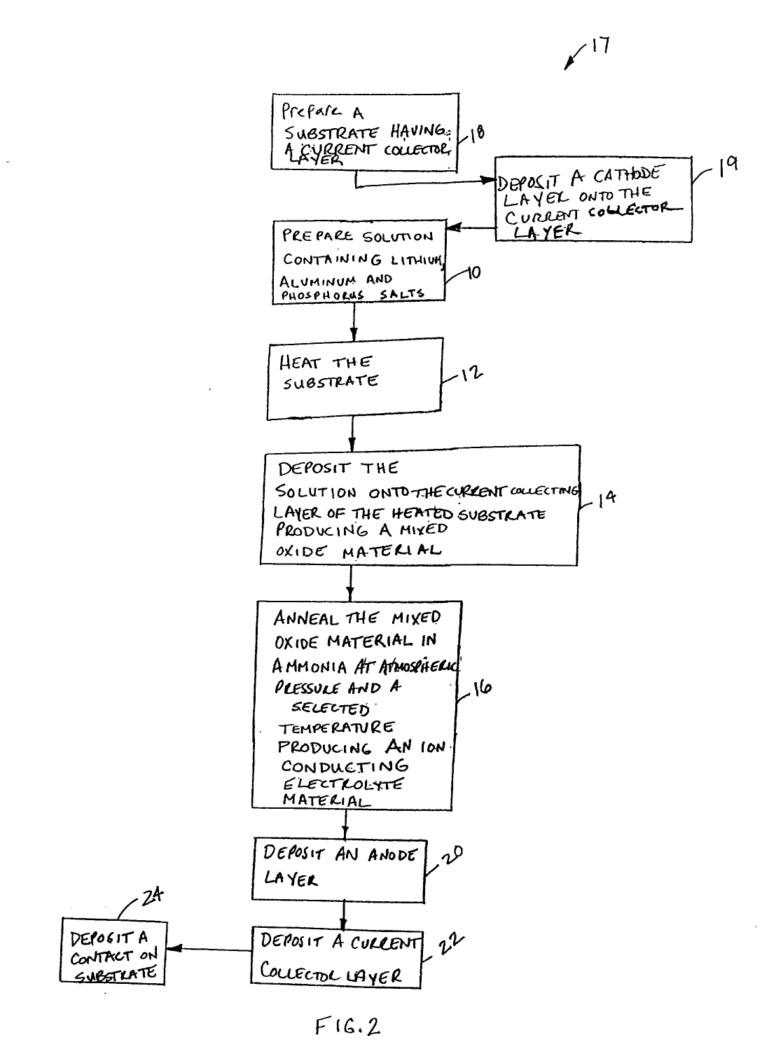

FIG. 2 is a flow chart 17 of a process for making a thin film battery having the ion-conducting electrolyte as provided in FIG. 1. At 18, a substrate is prepared having a thin film layer containing a current collector. At 19, a thin layer of cathode material is deposited onto the current collector layer. The cathode may be made of a lithium intercalation compound, preferably metal oxides such as LiNiO₂, V₂O₅, LiₓMn₂O₄, LiCoO₂ or TiS₂. At 10-12, the process continues as described in the flow chart of FIG. 1. At 20, a thin film layer of anode material is deposited onto the layer containing the electrolyte material. Suitable anode materials include tin nitride (Sn₃N₄) and silicon-tin oxynitride (SiTON), when used in lithium ion thin film batteries, or other suitable materials such as lithium metal, zinc nitride or tin nitride or other metal suitable for alloying with lithium. At 22, a thin layer of current collector material is deposited onto the anode layer. The current collector material can include for instance, gold on top of a cobalt or gold on top of a titanium underlayer. At 24, a contact is deposited onto the substrate. The contact can include, for example, a thin film layer of nickel. In an alternative embodiment, the contact is deposited at an earlier step in the process, for instance at 18.

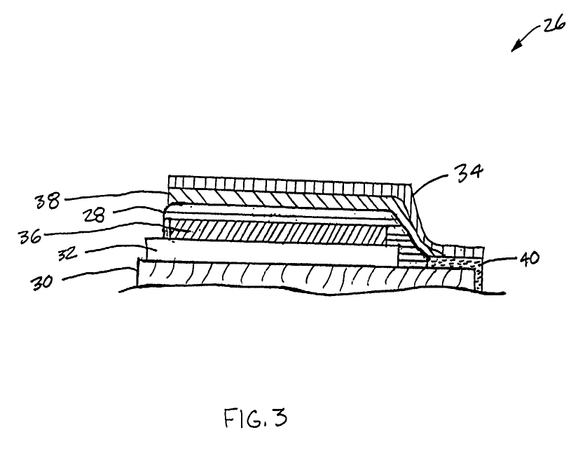

The deposition process described in FIGS. 1 and 2 achieve faster deposition rates than from other deposition methods, for instance sputtering. By using the methods and systems of this invention, fast deposition rates of approximately 1.5 μm/hr (250A/min) can be achieved. In an alternative embodiment, a protective coating is placed on top of the thin film battery made using the process described in FIGS. 2 and 3. A suitable protective coating for use with this invention is described in patent application Ser. No. 09/733,285, entitled “Packaging Systems And Methods For Thin Film Solid State Batteries,” filed Dec. 8, 2000, which is incorporated by this reference herein. The protective coating electrically insulates the thin film battery and prevents the battery components from deteriorating when exposed to ambient air, moisture and provides protection from high temperature manufacturing processes such as the solder reflow process.

FIG. 3 is a side view of a thin film battery 26 having the ion-conducting electrolyte 28 made from the process shown in FIG. 1. The electrolyte 28 is a thin film layer that can include materials such as, Li₂O-xAl₂O₃-yP₂O₅, and Li₃PO_{3.7} N_{0.3}. A substrate 30 provides the foundation for the thin film battery 26. The substrate underlying the thin film battery 26 may be comprised of glass, alumina, or various semiconductor or polymer materials. To enable electrical power to be withdrawn, the thin film battery 26 normally includes at least one current collector film 32, 34 deposited upon the substrate 30. A thin film cathode 36 may be positioned between the first current collector 32, also referred to as the cathode current collector, and the electrolyte 28. The electrolyte 28 has a thin film anode 38 deposited thereon. The current collector 34 on the anode 38 is also referred to as an anode current collector, is preferably made of copper or nickel, and may be positioned on a portion of the substrate to allow good electrical contact with the anode or cathode and an external charging device. A contact 40 such as a solderable contact may be mounted on the substrate 30. Preferably, the contact 40 comprises nickel. The anode current collector 34 substantially encases the anode 38, electrolyte 28, cathode 36, and cathode current collector 32 at one end and substantially covers the contact 40. A protective coating (not shown) as described in patent application Ser. No. 09/733,285, can be placed over the thin film battery 26 to protect the battery 26 from exposure to moisture.

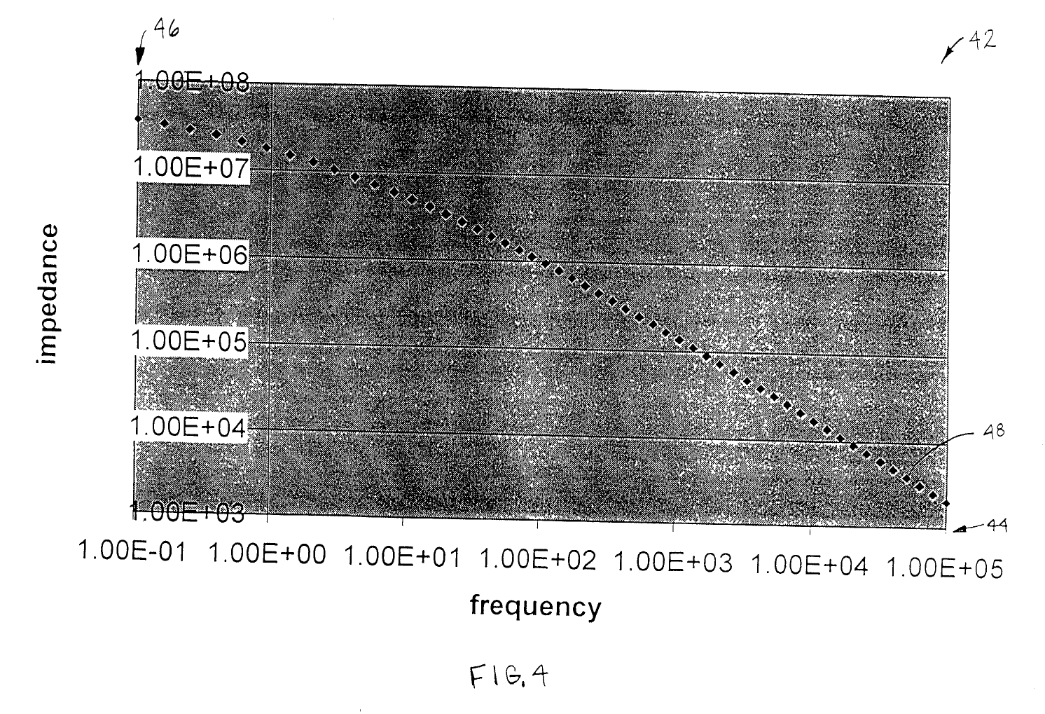

FIG. 4 is a graph 42 displaying an impedance spectrum of a thin film electrolyte material that has not been annealed in ammonia. The x-axis represents frequency 44 and the y-axis represents impedance 46. The performance results are obtained by attaching electrodes of either side of the thin film electrolyte material that allow AC current to flow through the thin film electrolyte material at different frequencies. The slope 48 of the graph 42 reflects the sharp drop off in impedance that occurs upon charging the electrolyte. The slope 48 reflects that the electrolyte has the performance characteristics of a dielectric material and is performing similarly to a capacitor and not as a conductor.

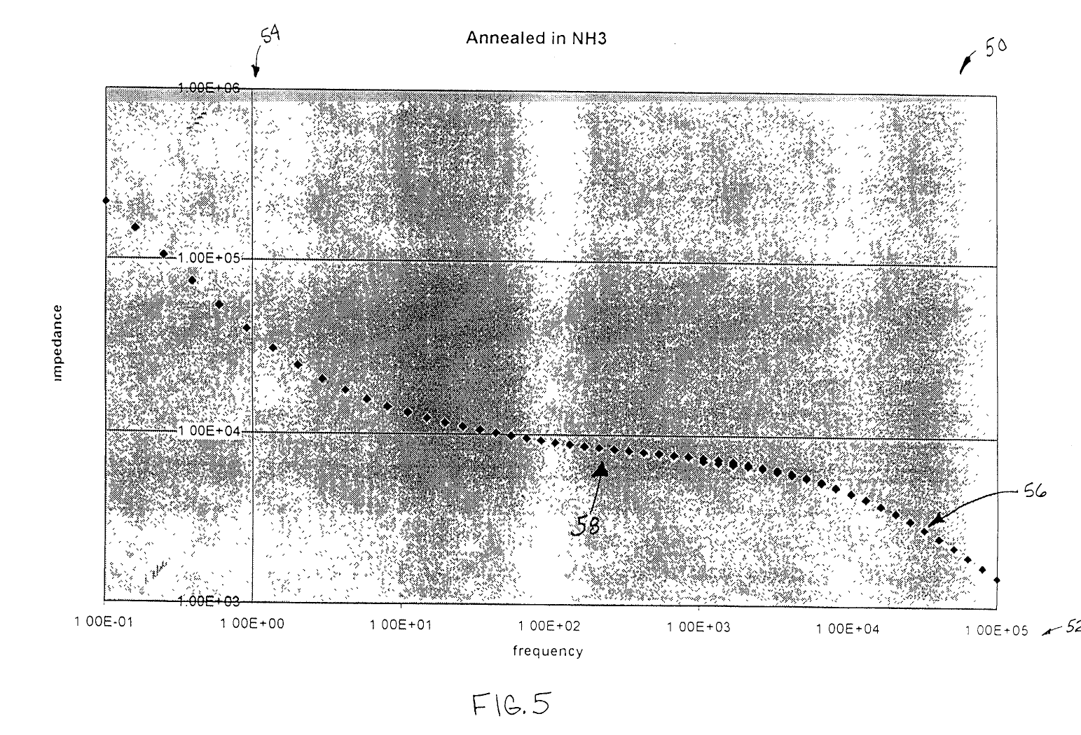

FIG. 5 is a graph 50 displaying the impedance spectrum for the same thin film electrolyte material of FIG. 4 after the electrolyte has been post-treated. Post-treating involves annealing the electrolyte in ammonia at atmospheric pressure at a temperature between 400-500° C. As in FIG. 4, the x-axis represents frequency 52 and the y-axis represents impedance 54. The slope 56 of the graph 50 displays a curve that is fairly flat with a minimum in phase angle. As shown in FIG. 5, the flat portion 58 exists over a relatively broad frequency spectrum that is characteristic of an ion conductor. Post-treating the electrolyte causes an atomic rearrangement in the electrolyte such that electrons are not conducted however ions are conducted.

An advantage of this invention is that the methods described provide for a production process that achieves higher deposition rates than when using a sputtering process. In addition, as an open-air process the technique provides flexibility to the configuration and arrangement of production equipment, and deposition area is not confined to that dictated by the design of vacuum chambers.

Another advantage of this invention is that by annealing in ammonia, an improved ion conducting behavior in the electrolyte thin film layer is achieved because the incorporation of nitrogen forms an oxynitride phase which has a two orders of magnitude higher conductivity than if the mixed oxide material was not annealed with ammonia.

Yet advantage of this invention is that it provides for a fast deposition method for the lithium ion conductor of approximately 1.5 μm per hour.

The foregoing is provided for purposes of illustrating, explaining and describing several embodiments of this invention. Modifications and adaptations to these embodiments will be apparent to those of ordinary skill in the art and may be made without departing from the scope or spirit of the invention and the following claims. Also, the embodiments described in this document in no way limit the scope of the below claims as persons skilled in this art recognize that this invention can be easily modified for use to provide additional functionalities and for new applications.

We claim:

1. A method of forming an ion-conducting electrolyte, comprising:
a. mixing a solution of lithium, aluminum and phosphorus compounds;
b. spraying the solution onto a substrate forming a mixed oxide material;
c. treating the mixed oxide material in ammonia at an atmospheric pressure; and
d. annealing the mixed oxide material containing ammonia at a selected temperature resulting in a material having ion conducting behavior.

2. The method of claim 1 further comprises heating the substrate to a temperature between 300-500° C.

3. The method of claim 1 further comprises heating the mixed oxide material containing ammonia at a temperature about 500° C.

4. A method of producing a thin film battery comprising:
a. providing a current collector;
b. depositing a cathode compound upon the current collector;
c. mixing a solution of lithium, aluminum and phosphorus compounds;
d. spraying the solution onto the cathode compound forming a mixed oxide material;
e. treating the mixed oxide material in ammonia at an atmospheric pressure;
f. annealing the mixed oxide material containing ammonia at a selected temperature resulting in a material having good ionic conductivity;
g. depositing an anode upon the material having ion-conducting behavior; and
h. depositing a second current collector upon the anode.

5. The method of claim 4, further comprising adding a protective coating including a layer of aluminum oxide over an upper layer of the thin film battery and a layer of silicon dioxide on top of the layer of aluminum oxide and epoxy deposited over the entire thin film battery that is cured and annealed.

6. The method of claim 4, wherein the providing a current collector step is performed using the current collector comprising gold on top of a cobalt underlayer.

7. The method of claim 4, wherein the providing a current collector step is performed using the current collector comprising gold on top of a titanium underlayer

8. The method of claim 4, wherein the depositing an anode upon the material having ion-conducting behavior step is performed using anode material selected from group consisting of silicon-tin oxynitride, lithium metal, zinc nitride or tin nitride.

9. The method of claim 4, wherein the spraying the solution onto the cathode compound forming a mixed oxide material step is performed using a metal oxide cathode material.

10. The method of claim 4, wherein the spraying the solution onto the cathode compound forming a mixed oxide material step is performed using cathode material selected from the group consisting of LiNiO₂, V₂O₅, LiₓMn₂O₄, LiCoO₂ or TiS₂.

11. The method of claim 4, wherein the annealing the mixed oxide material containing ammonia at a selected temperature resulting in a material having ion-conducting behavior step is performed at a temperature between 400-500° C.

12. A thin film battery comprising:
a. a current collector including gold on top of a cobalt underlayer that substantially covering a substrate;
